(19) United States
(12) Patent Application Publication
(10) Pub. No.: US 2025/0003859 A1
(43) Pub. Date: Jan. 2, 2025

(54) Systems and Methods of Cell Sorting Implementing Artificial Intelligence

(71) Applicant: Life Technologies Corporation, Carlsbad, CA (US)

(72) Inventors: Samuel Henry Adler Rudy, Fort Collins, CO (US); Daniel Nelson Fox, Fort Collins, CO (US); Nicholas John Rohrbacker, Fort Collins, CO (US)

(21) Appl. No.: 18/756,372

(22) Filed: Jun. 27, 2024

Related U.S. Application Data
(60) Provisional application No. 63/510,959, filed on Jun. 29, 2023.

(51) Int. Cl. G01N 15/1429; G01N 15/01; G01N 15/10; G01N 15/149

(52) U.S. Cl. CPC G01N 15/1429; G01N 15/01; G01N 15/149; G01N 2015/016; G01N 2015/1028

(57) ABSTRACT

Disclosed herein are apparatuses, systems, as well as related methods, computing devices, and computer-readable media related to real time cell sorter cell sorting using embeddings. For example, in some embodiments a method may comprise receiving first cell sorter data. The first cell sorter data may include cell sorter data including microscopy data, hyperspectral imaging data, high-dimensional vector data, or one or more combinations thereof. In some embodiments, the cell sorter data may include quantitative fluorescence data expressed as one or more of antibodies bound per cell, antibody binding capacity (ABC), molecules of equivalent soluble fluorochrome (MESF), one or more other quantitative indicators of fluorescence, or one or more combinations thereof. In some embodiments, the quantitative fluorescence data includes one or more fluorescence signals from: one or more fluorescent proteins, one or more fluorescent dyes, one or more fluorescently conjugate antibodies, or one or more combinations thereof.

### CROSS-REFERENCE TO RELATED APPLICATIONS

This application is a non-provisional application which claims benefit to U.S. Provisional Application No. 63/510,959, filed Jun. 29, 2023, the entirety of which is incorporated by reference herein.

### BACKGROUND

Cell sorting generally involves sorting of cells from a heterogeneous sample of cells, but sorting cells presents many challenges. Current strategies for cell sorting based on nonlinear embeddings rely on algorithms that construct sequences of exclusionary gates drawn on two-dimensional density plots based on cell marker expression levels. These gates and sequences are subjective, potentially inexact, and incapable of using relations between three or more cell markers on a single gate. Thus, there is a need for more sophisticated techniques for sorting cells and related analysis. The present invention addresses this need.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings. The drawings include a number of features that are not discussed in detail herein for clarity of exposition, but the purpose and operation of these features will be understood by one of ordinary skill in the art and may take any suitable form. Any of the features of the drawings may be used in combination with any suitable ones of the features of other of the accompanying drawings and/or in combination with any suitable ones of the features of the embodiments disclosed herein.

FIGS. 1A, 1B and 1C are block diagrams of exemplary cell sorter support modules for performing support operations, in accordance with various embodiments.

FIGS. 2A, 2B and 2C are flow diagrams of exemplary methods of performing support operations, in accordance with various embodiments.

FIG. 3 is an example of a graphical user interface that may be used in the performance of some or all of the support methods disclosed herein, in accordance with various embodiments.

FIG. 4 is a block diagram of an example computing device that may perform some or all of the cell sorter support methods disclosed herein, in accordance with various embodiments.

FIG. 5 is a block diagram of an example cell sorter support system in which some or all of the cell sorter support methods disclosed herein may be performed, in accordance with various embodiments.

FIGS. 6A, 6B and 6C are exemplary workflows as contemplated by embodiments of the present disclosure. In FIG. 6A, the left panel depicts a spectral cell sorter recording cells as events. The spectral cell sorter is equipped to capture a detailed spectral signature of each cell. The middle panel is a graphical representation of a neural network for processing the spectral signature. The right panel depicts exemplary gating on a parametric embedding. FIG. 6B depicts an exemplary workflow using a neural network that is trained to reproduce a non-parametric embedding. FIG. 6C depicts an exemplary workflow using neural network that is trained to directly produce a parametric embedding.

FIGS. 7A, 7B and 7C depict a simple representative gating progression (progressing from 7A to 7B to 7C) of a cell sample sorted for CD4+ T cells using a spectral cell sorter.

FIGS. 8A and 8B depict plots of CD4+ T cells highlighted in both a tSNE (FIG. 8A) embedding and UMAP (FIG. 8B) embedding.

FIGS. 9A and 9B depict an exemplary selection of clusters from an embedding (FIG. 9A), and subsequent traditional gating sequences (FIGS. 9B and 9C) determined using a gate-finding algorithm as contemplated herein.

FIGS. 10A to 10D depict graphical representations of exemplary mapping processes as contemplated by the present disclosure. FIGS. 10A and 10B show the workflow using a neural network to reproduce a non-parametric embedding. FIGS. 10C and 10D shows the workflow using a network trained to produce the embedding directly. The top panels of FIG. 10A depict identical gates shown on an initial non-parametric UMAP embedding, the neural network scoring on the training data comprising 9901 events, and the neural network scoring of the remaining 255,975 events. The top panels of FIG. 10C depict gates shown on neural network scoring of the training data comprising 9901 events, and the neural network scoring of the remaining 255,975 events. The lower panels show box-and-whisker plots showing similarity of medians and percentile ranges for the above gates across embeddings.

### DETAILED DESCRIPTION

Disclosed herein are apparatuses, systems, as well as related methods, computing devices, and computer-readable media related to real time cell sorter cell sorting using embeddings. For example, in some embodiments a method may comprise receiving first cell sorter data. The first cell sorter data may include cell sorter data. The cell sorter data can include fluorescence data, light scatter data, and/or a combination thereof. The first cell sorter data may also include microscopy data, hyperspectral imaging data, multispectral data, high-dimensional vector data, or one or more combinations thereof. In some embodiments, the cell sorter data may include quantitative fluorescence data. The quantitative fluorescence data can include fluorescence intensity values associated with one or more fluorochromes or fluorophores. Each of the one or more fluorochromes or fluorophores can be associated with a cell or protein marker associated with one or more cell populations. The one or more fluorochromes or fluorophores can be associated with or conjugated to one or more antibodies. The quantitative fluorescence data can be presented as a two-dimensional or three-dimensional linear plot, a two-dimensional or three-dimensional logarithmic plot, a two-dimensional or three-dimensional logicle plot, or one or more combinations thereof. The quantitative fluorescence data can be presented as one or more combinations of fluorochromes or fluorophores, each corresponding to a protein marker, cell marker, or the like. The quantitative fluorescence data include compensated data, uncompensated data, and/or a combination thereof. The quantitative fluorescence data can be expressed as mean fluorescence intensity (MFI). In some embodiments, the cell sorter data can include light scatter data. The light scatter data can include forward light scatter, side light scatter, and/or a combination thereof. The light scatter data can be presented as a two-dimensional or three-dimensional linear plot.

The methods may include determining, based on applying a mapping process to the first cell sorter data, a representation such as a cluster of the first cell sorter data. In some embodiments, the mapping process may include one or more of a clustering process, a dimensionality reduction process, an embedding, a non-parametric embedding, or one or more combinations thereof. As used herein, the term ‘embedding’ refers to a representation of a dataset that is produced by a nonlinear dimensionality reduction algorithm. The term ‘nonlinear’ is understood to exclude dimensionality reduction techniques that may be expressed as affine transformations, such as principal component analysis. Examples of nonlinear dimensionality reductions algorithms can include t-distributed stochastic neighbor embedding (tSNE), uniform manifold approximation and projection (UMAP), pairwise controlled manifold approximation and projection (PaCMAP), Laplacian Eigenmaps, Isomap, Local Linear Embedding, and/or related methods. As used herein, the term ‘parametric embedding’ refers to an embedding or approximation of an embedding where coordinates in the reduced dimensional space are determined via passing individual data points from the dataset though a computational model. The embedding coordinates can correspond to a dot on a scatterplot. The embedding can include a uniform Manifold Approximation and Projection (UMAP), a t-distributed Stochastic Neighbor Embedding (t-SNE)) another type of nonlinear embedding, or a combination thereof. The computational model can include a trained machine learning model such as a trained neural network. In some embodiments, a mapping process can be used to transform data having a higher number of dimensions to a representation of the transformed data having a lower number of dimensions. For example, in some embodiments, the mapping process can transform three-dimensional data into two-dimensional data. In some embodiments, the mapping process can transform high dimensional data, including data having 3, 4, 5, 6, 7, 8, 9, 10, 11, 12, 13, 14, 15, 16, 17, 18, 19, 20 or more than 20 dimensions into data having 2 or 3 dimensions. In some embodiments, the transformed data includes contextually optimized data. In some embodiments, the lower dimensional transformed data representation is optimized to preserve one or more features of a high dimensional representation. In some embodiments, the representation of the data includes one or more clusters of data, for example cell sorter data for separating into subsequent representations of data. In some embodiments, the representation of the first cell sorter data and the representation of the second cell sorter data each comprise a corresponding two-dimensional plot, three-dimensional plot, any/or a combination thereof.

The methods may include training, based on the first cell sorter data and a first representation of the first cell sorter data, a machine learning model, for example, a trained neural network. In some embodiments, the neural network includes one or more of an artificial neural network, a convolutional neural network, a recurrent neural network, or one or more combinations thereof. The methods may include training the neural network without prior determination of a first representation of the first cell sorter data in a manner yielding both a representation of the first cell sorter data and a trained neural network generating the representation of the first cell sorter data. In some embodiments, the representation comprises a parametric embedding.

In some embodiments, the method includes receiving second cell sorter data. The cell sorter data can include fluorescence data, light scattering data, and/or a combination thereof. The second cell sorter data may also include microscopy data, hyperspectral imaging data, multispectral data, high-dimensional vector data, or one or more combinations thereof. In some embodiments, the cell sorter data may include quantitative fluorescence data expressed as one or more of antibodies bound per cell, antibody binding capacity (ABC), molecules of equivalent soluble fluorochrome (MESF), or one or more other quantitative indicators of fluorescence. In some embodiments, the quantitative fluorescence data comprises one or more fluorescence signals from one or more fluorescent proteins, one or more fluorescent dyes, one or more fluorescently conjugate antibodies, or one or more combinations thereof.

The methods may include determining, based on the trained machine learning model, a representation of the second cell sorter data. In some embodiments, the step of determining the representation of the second cell sorter data includes performing sorting of the second cell sorter data using a field programmable gate array optimized for performing real-time sorting decisions on a cell sorter. In some embodiments, the step of determining the representation of the second cell sorter data includes processing computations of the machine learning model at a rate of up to about 100,000 events per second, or greater than about 100,000 events per second. The processing may occur parallel. The processing may not occur in parallel.

In some embodiments, the methods further include receiving user input indicating one or more groupings associated with the representation of the first cell sorter data where the one or more groupings include one or more signal clusterings or gatings. In some embodiments, the one or more groupings comprise one or more signal clusterings or gatings for one or more parameters. For example, the grouping may include clusterings or gatings for removing doublets, selecting for viability, based on a particular light scatter, selecting for expression of one or more specific lineage markers, or one or more combinations thereof. The one or more specific lineage markers can include any known phenotypic markers as understood in the art. For example, the one or more lineage markers can include any known marker of a lymphocyte, monocyte, neutrophil, eosinophil, basophil, or one or more combinations thereof. The one or more lineage markers can include any suitable marker of a tumor cell, cancer cell, inflammatory cell, and the like.

In some embodiments, the methods may further include determining, based on the one or more groupings and the machine learning model, classification of the second cell sorter data. In some embodiments, the methods may further include causing, based on the classification, a device such as a cell sorter to sort a portion of a sample. For example, the device may sort a portion of a cellular sample thereby separating a subset of cells. The subset of cells may express one or more markers of interest including for example one or more phenotypic markers of interest. For example, the subset of cells may express one or more markers of a lymphocyte, monocyte, neutrophil, eosinophil, basophil, or one or more combinations thereof. In some embodiments, the subset of cells may express any suitable marker of a tumor cell, cancer cell, inflammatory cell, and the like.

Another example method may include receiving cell sorter measurement data associated with one or more sensors of a cell sorter instrument device. In some embodiments, the method includes determining, based on inputting the received cell sorter data to a machine learning model, a representation of the cell sorter data associated with a mapping process. In some embodiments, the representation of cell sorter data comprises one or more clusters of data for separating into subsequent representations of data. In some embodiments, the representation of the cell sorter data includes a two-dimensional plot, a three-dimensional plot, and/or a combination thereof. The representation can include an embedding such as a parametric embedding. The method may include causing output of the representation of the cell sorter data. In some embodiments, the causing output step may include one or more of displaying the representation of the cell sorter data, sending the representation of the cell sorter data via a network to a computing device, causing an update to a user interface configured to control a cell sorter to render a measurement, or a combination thereof. The representation of the cell sorter data can include a scatterplot. In some embodiments, each of the dots on the scatterplot correspond to a particle or cell. The method may further include receiving user input based on the output representation of the cell sorter data and sorting a plurality of particles including for example a plurality of cells or a portion of a sample of cells, based on the user input. In some embodiments, the user input includes assigning a gating threshold based on the cell sorter data. The gating instructions or gating threshold can include the user drawing a gate on a parametric embedding based on the first cell sorter data. The user drawn gate may include one or more of a polygon, ellipse, closed curve, and the like.

Another example method includes determining, based on user input, one or more configuration parameters for training a machine learning model for an instrument device such as a cell sorter. The configuration parameters can include specifications for defining the machine learning model. In some embodiments, the specifications can include weights. The method can include receiving first cell sorter data including, for example cell sorter data from the instrument device (e.g., cell sorter device).

The method can include determining a first representation of the first cell sorter data based on applying a mapping process to the first cell sorter data. The representation of the data may include, for example, a two-dimensional plot, a three-dimensional plot, and/or a combination thereof. The mapping process may include a clustering process, a dimensionality reduction process, an embedding and/or one or more combinations thereof. The embedding may include a uniform Manifold Approximation and Projection (UMAP) a t-distributed Stochastic Neighbor Embedding (t-SNE)), or other nonlinear embedding, and/or a combination thereof. In some embodiments, the mapping process transforms data having a higher number of dimensions to a representation of the data having a lower number of dimensions.

The method can include training, based on the first cell sorter data and a first representation of the first cell sorter data, a machine learning model. The machine learning model may include a deep learning model. For example, the machine learning model can include a neural network. In some embodiments, the neural network may include one or more of an artificial neural network, a convolutional neural network, a recurrent neural network, or one or more combinations thereof.

The method can include causing storage of the machine learning model. The machine learning model may be stored using a computer processor in communication with the cell sorter. The machine learning model can be stored using a short-term storage component. The machine learning model can be stored using a long-term storage component. In some embodiments, the machine learning model can be stored using one or more components including for example a field programmable gate array (FPGA). The computer processor may be configured to use the stored machine learning model to analyze second cell sorter data including for example, cell sorter data received from the instrument device. The second cell sorter data can include microscopy data, hyperspectral imaging data, high-dimensional vector data, or one or more combinations thereof. The cell sorter data can include quantitative fluorescence data expressed as one or more of antibodies bound per cell or antibody binding capacity (ABC), molecules of equivalent soluble fluorochrome (MESF), one or more other quantitative indicators of fluorescence, or one or more combinations thereof. The cell sorter data can include one or more fluorescence signals from: one or more fluorescent proteins, one or more fluorescent dyes, one or more fluorescently conjugate antibodies, or one or more combinations thereof.

In certain aspects, the present disclosure provides a method of sorting a sample comprising a plurality of particles, the method comprising determining, based on applying a trained machine learning model to the first cell sorter data, a representation of the first cell sorter data. The representation can include a parametric embedding. The parametric embedding can include a two-dimensional scatterplot wherein each dot on the scatterplot corresponds to a cell or particle. In some embodiments, the method can include a step of training a machine learning model based on one or more of the first cell sorter data, user input, a first representation of the first cell sorter data or a combination thereof. In some embodiments, the method can include a step of receiving second cell sorter data associated with a second portion of the sample of one or more cells. In some embodiments, the methods can include a step of sorting, based on a classification determined from the trained machine learning model and/or user supplied gating instructions, a portion of the sample.

In certain aspects, the present disclosure provides a method of sorting a sample comprising a plurality of particles or cells. In some embodiments, of the method can include collecting first cell sorter data associated with a first portion of a sample of one or more cells. In some embodiments, the method can include determining, based on applying a mapping process to the first cell sorter data, a first representation of the first cell sorter data. In some embodiments, the method can include training, based on one or more of the first cell sorter data, user input, a first representation of the first cell sorter data or a combination thereof, a machine learning model. In some embodiments, the method can include determining, based on the first measurement data and trained machine model, a parametric embedding of the first cell sorter data. Embodiments of the method can include receiving from the user one or more gating instructions using the first cell sorter data, the parametric embedding of the first cell sorter data, or a combination thereof. Embodiments of the method can include receiving second cell sorter data associated with a second portion of the sample of one or more cells. Embodiments of the method can include determining, using the trained machine learning model, embedding coordinates of the second cell sorter data. Embodiments of the method can include determining, based on the embedding coordinates of the second cell sorter data and the user-supplied gating instructions, a classification of the second cell sorter data. Embodiments of the method can include sorting, based on the classification, a portion of the sample.

In certain aspects, the present disclosure provides a device comprising one or more processors; and a memory storing instructions that, when executed by the one or more processors, cause the device to perform any of the methods as disclosed herein.

In certain aspects, the present disclosure provides a non-transitory computer-readaeaic medium storing instructions that, when executed by one or more processors, cause a device to perform any of the methods as disclosure herein.

In certain aspects the present disclosure provides a system comprising a cell sorter comprising one or more sensors configured to generate cell sorter data; and a computing device comprising one or more processors, and a memory, wherein the memory stores instructions that, when executed by the one or more processors, cause the computing device to perform any of the methods as disclosed herein. For example, the memory can store one or more weights associated with one or more trained machine learning models including, for example, one or more trained neural networks, as disclosed herein. The term “weights” as used herein in reference to a neural network, refers to all parameter values and network structure definitions necessary to propagate input data through the neural network in order to obtain an output value.

The cell sorter system embodiments disclosed herein may achieve improved performance relative to conventional approaches. For example, existing strategies for cell sorting derived from clusters obtained from a nonlinear embedding of cell sorter data rely on gate-finding algorithms that draw a sequence of two-dimensional gates based on cell marker expression levels. As used herein, the term ‘gate-finding’ refers to the process of finding a sequence of two-dimensional gates based on cell marker expression levels, scatter data, fluorescence measurements, and/or a combination thereof that approximates a gate drawn on an embedding. These algorithms are inexact and incapable of using relations between three or more cell markers on a single gate. This invention solves this problem by learning a parametric representation of the embedding using a machine learning model, for example a neural network that, combined with an integrated, fast computational architecture, allows for real time embedding of new datapoints and sorting based on embedding coordinates. The embodiments disclosed herein thus provide improvements to cell sorter technology, for example, improvements in the computer technology supporting such cell sorters, among other improvements.

Various methods and cell sorter systems of the embodiments disclosed herein may improve upon conventional approaches to achieve the technical advantages of higher throughput, more exact algorithms, and faster cell sorting by making use of a machine learning model, for example a trained neural network that allows for real-time processing of cell sorter data and sorting of cells, and displaying of representations of cell sorter data. Such technical advantages are not achievable by routine and conventional approaches, and all users of systems including such embodiments may benefit from these advantages, for example, by assisting the user in the performance of a technical task, such as real-time high-throughput cell sorting, by means of a guided human-machine interaction process. The technical features of the embodiments disclosed herein are thus decidedly unconventional in the field of cell sorter, as are the combinations of the features of the embodiments disclosed herein. The present disclosure thus introduces functionality that neither a conventional computing device, nor a human, could perform. As used herein, the term ‘weights,’ in reference to a neural network, refers to all parameter values and network structure definitions necessary to propagate input data through the neural network to obtain an output value.

The embodiments disclosed herein thus provide improvements to cell sorting/cell sorter technology, for example, improvements in the computer technology supporting cell sorters, among other improvements.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may be performed in an order different than that presented herein. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

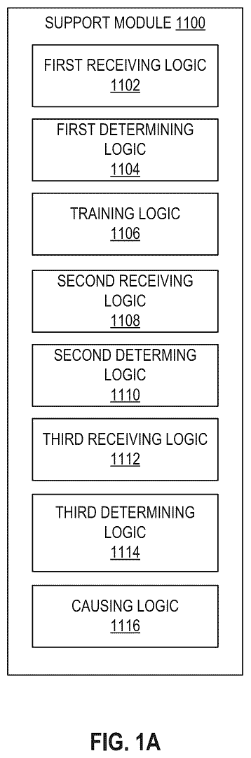

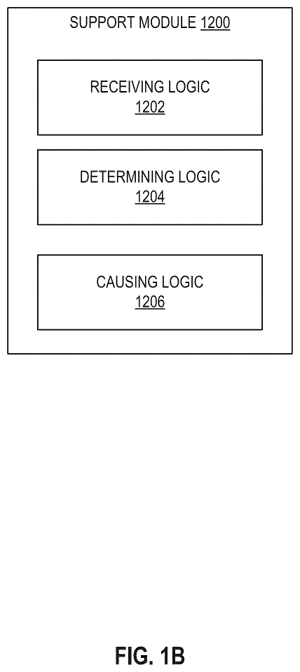

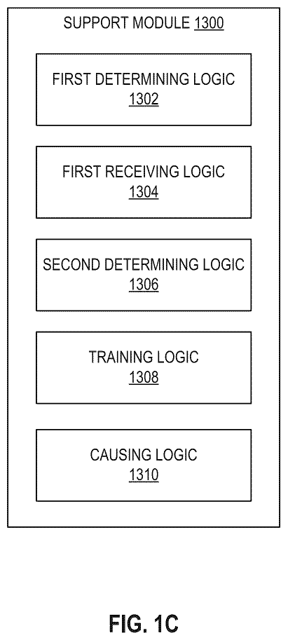

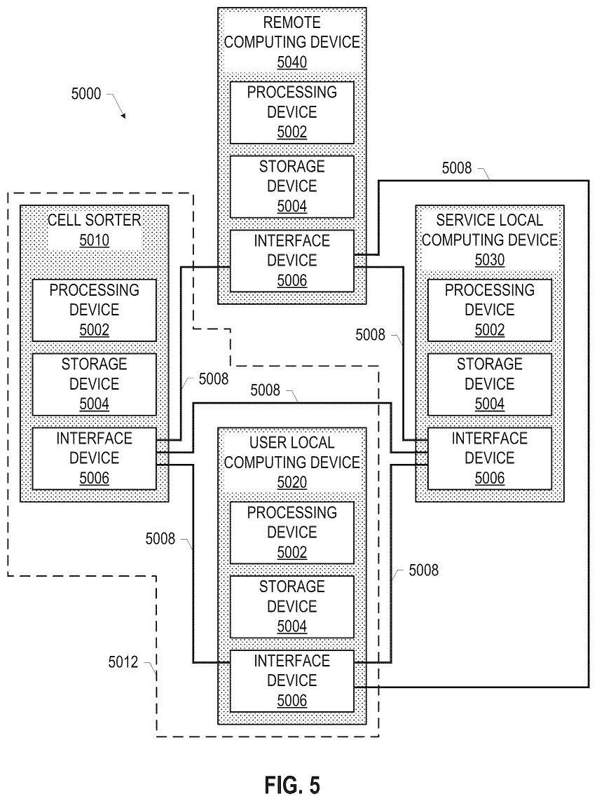

FIG. 1A is a block diagram of a cell sorter support module 1100 for performing support operations, in accordance with various embodiments. The cell sorter support module 1100 may be implemented by circuitry, for example, including electrical and/or optical components, such as a programmed computing device. The logic of the cell sorter support module 1100 may be included in a single computing device or may be distributed across multiple computing devices that are in communication with each other as appropriate. Examples of computing devices that may, singly or in combination, implement the cell sorter support module 1100 are discussed herein with reference to the computing device 4000 of FIG. 4, and examples of systems of interconnected computing devices, in which the cell sorter support module 1100 may be implemented across one or more of the computing devices, is discussed herein with reference to the cell sorter support system 5000 of FIG. 5.

The cell sorter support module 1100 may include first receiving logic 1102, first determining logic 1104, training logic 1106, second receiving logic 1108, and second determining logic 1110. Embodiments of the cell sorter support module 1100 may further include the third receiving logic 1112, the third determining logic 1014, and the causing logic 1116. As used herein, the term “logic” may include an apparatus that is to perform a set of operations associated with the logic. For example, any of the logic elements included in the support module 1100 may be implemented by one or more computing devices programmed with instructions to cause one or more processing devices of the computing devices to perform the associated set of operations. The one or more computing devices can include, for example, one or more FPGAs. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The first receiving logic 1102 may receive first cell sorter data from a cell sorter device. The cell sorter data may be received in the form of fluorescence signal data, light scatter data, and/or a combination thereof. The fluorescence signal may be obtained from one or more cells in a sample. Alternatively, the first cell sorter data can include fluorescence signal data such as microscopy data, hyperspectral imaging data, multispectral imaging data, high-dimensional vector data, or one or more combinations thereof. The cell sorter data may include quantitative fluorescence data expressed as one or more of antibodies bound per cell, antibody binding capacity (ABC), molecules of equivalent soluble fluorochrome (MESF), one or more other quantitative indicators of fluorescence, or one or more combinations thereof.

The first determining logic 1104 may determine, based on applying a mapping process to the first cell sorter data, a first representation of the first cell sorter data. The mapping process may include one or more of a clustering process, a dimensionality reduction process, an embedding, a non-parametric embedding, or one or more combinations thereof. The embedding may include one or more of a uniform Manifold Approximation and Projection (UMAP) a t-distributed Stochastic Neighbor Embedding (t-SNE), or another type of nonlinear embedding, or a combination thereof. The representation may include one or more clusters of data for separating into subsequent representations of data. The representation of the data may be in the form of a two-dimensional plot, a three-dimensional plot, and/or a combination thereof.

The training logic 1106 may train a machine learning model based on the first cell sorter data and a first representation of the first cell sorter data. The machine learning model may include a neural network trained to learn the mechanism of the mapping process for generating one or more representations of the data for a cell sorter measurement session. The neural network can be trained without prior determination of a first representation of the first cell sorter data in a manner yielding both a representation of the first cell sorter data and a trained neural network generating the representation of the first cell sorter data. The neural network may include one or more of an artificial neural network, a convolutional neural network, a recurrent neural network, or one or more combinations thereof.

The second receiving logic 1108 may receive second cell sorter data from a cell sorter device. The second cell sorter data can include cell sorter data received in the form of fluorescence signal data, light scatter data, and/or a combination thereof. Alternatively, the second cell sorter data can include fluorescence signal data such as microscopy data, hyperspectral imaging data, multispectral imaging data, high-dimensional vector data, or one or more combinations thereof. The fluorescence signal may be obtained from one or more cells in a sample. The fluorescence signal data can include quantitative fluorescence data expressed as one or more of antibodies bound per cell, antibody binding capacity (ABC), molecules of equivalent soluble fluorochrome (MESF), one or more other quantitative indicators of fluorescence, or one or more combinations thereof.

The second determining logic 1110 may determine a representation of the second cell sorter data based on the trained machine learning model. The representation of the data may include one or more clusters of data for separating into subsequent representations of data. The representation of the data may be in the form of a two-dimensional plot, a three-dimensional plot, and/or a combination thereof. The two-dimensional plot or three-dimensional plot can include a scatterplot. Each of the dots on the scatterplot can correspond to a particle or cell. The determining the representation of the second cell sorter data may include performing sorting of the second cell sorter data using a field programmable gate array (FPGA). The FPGA may be optimized for performing real-time sorting decisions on a cell sorter. The sorting decisions can be performed in up to about 100 μs, in from about 100 μs to about 300 μs, in from about 300 μs to about 500 μs, in from about 500 μs to about 700 μs, in from about 700 μs to about 900 μs, in from about 900 μs to about 1 ms, in from about 1 ms to about 2 ms, from about 2 ms to about 5 ms, from about 5 ms to about 10 ms, in from about 10 ms to about 25 ms, in from about 25 ms to about 50 ms, in from about 50 ms to about 75 ms, in from about 75 ms to about 100 ms, in from about 100 ms to about 500 ms, in from about 500 ms to about 1 s, in from about 1 s to about 2 s, in from about 2 s to about 5 s, in from about 5 s to about 10 s, including any and all increments therebetween.

The third receiving logic 1112 may receive user input indicating one or more groupings associated with the representation of the first cell sorter data.

The third determining logic 1114 may determine the classification of the second cell sorter data based on the one or more groupings and the machine learning model.

The causing logic 1116 may cause a device to sort a portion of a sample based on the classification determined by third determining logic 1114. The sample may include a cell sample. For example, the sample may include a sample of one or more cell types a lymphocyte, monocyte, neutrophil, eosinophil, basophil, or one or more combinations thereof. In some embodiments, the cell sample may include a sample of tumor cells, cancer cells, inflammatory cells, epithelial cells, endothelial cells, gamete cells, somatic cells, and the like including one or more combinations thereof.

FIG. 1B is a block diagram of a cell sorter support module 1200 for performing support operations, in accordance with various embodiments. The cell sorter support module 1200 may be implemented by circuitry including, for example, electrical and/or optical components, such as a programmed computing device. The logic of the cell sorter support module 1200 may be included in a single computing device or may be distributed across multiple computing devices that are in communication with each other as appropriate. Examples of computing devices that may, singly or in combination, implement the cell sorter support module 1200 are discussed herein with reference to the computing device 4000 of FIG. 4, and examples of systems of interconnected computing devices, in which the cell sorter support module 1100 may be implemented across one or more of the computing devices, is discussed herein with reference to the cell sorter support system 5000 of FIG. 5.

The cell sorter support module 1200 may include first receiving logic 1202, first determining logic 1204, and a causing logic 1206. In some embodiments cell sorter support module 1200 may optionally include a second receiving logic 1208 (not shown). As used herein, the term “logic” may include an apparatus that is to perform a set of operations associated with the logic. For example, any of the logic elements included in the support module 1100 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The first receiving logic 1202 may receive cell sorter measurement data associated with one or more sensors of a cell sorter instrument device. The instrument device can include cell sorter device. The one or more sensors can include one or more fluorescence detectors. The cell sorter data can include cell sorter data received in the form of fluorescence signal data. For example, the fluorescence signal data can include hyperspectral imaging data, high-dimensional vector data, or one or more combinations thereof. The fluorescence signal may be obtained from one or more cells in a sample. The one or more cells may be transformed to express one or more fluorescence proteins. The one or more cells may be labeled with one or more fluorophores or other fluorescent labels. The fluorescence signal data can include quantitative fluorescence data expressed as one or more of antibodies bound per cell, antibody binding capacity (ABC), molecules of equivalent soluble fluorochrome (MESF), one or more other quantitative indicators of fluorescence, or one or more combinations thereof.

The first determining logic 1204 may determine, based on inputting the cell sorter data to a machine learning model, a representation of the cell sorter data. The representation may include one or more clusters of data for separating into subsequent representations of data. The representation of the data may be in the form of a two-dimensional plot, a three-dimensional plot, and/or a combination thereof. The two-dimensional plot or three-dimensional plot can include a scatterplot. Each dot on the scatterplot can correspond to a cell or particle. The machine learning model may include a neural network trained to learn the mechanism of the mapping process for generating one or more representations of the data for a cell sorter measurement session. The mapping process may include one or more of a clustering process, a dimensionality reduction process, an embedding, a parametric embedding, a non-parametric embedding, and/or a combination thereof. The embedding may include a uniform Manifold Approximation and Projection (UMAP) a t-distributed Stochastic Neighbor Embedding (t-SNE), or other nonlinear embedding, and/or a combination thereof. The neural network may include one or more of an artificial neural network, a convolutional neural network, a recurrent neural network, or one or more combinations thereof.

The causing logic 1206 may cause a cell sorter device to sort a portion of a sample based on the classification determined by third determining logic 1014. The sample may include a cell sample. For example, the sample may include a sample of one or more cell types a lymphocyte, monocyte, neutrophil, eosinophil, basophil, or one or more combinations thereof. In some embodiments, the cell sample may include a tumor cell, a cancer cell, an inflammatory cell, and the like including one or more combinations thereof.

The second receiving logic 1208 may receive second cell sorter data from a cell sorter device. The second cell sorter data can include cell sorter data received in the form of fluorescence signal data, light scatter data, and/or a combination thereof. The fluorescence signal may be obtained from one or more fluorescent particles in the sample. The fluorescence signal may be obtained from one or more cells in a sample. The cells can include cells transformed to express one or more fluorescent proteins. The cells can include cells labeled with one or more fluorophores or fluorescent probes. The fluorescence signal data can include quantitative fluorescence data expressed as one or more of antibodies bound per cell, antibody binding capacity (ABC), molecules of equivalent soluble fluorochrome (MESF), one or more other quantitative indicators of fluorescence, or one or more combinations thereof.

FIG. 1C is a block diagram of a cell sorter support module 1300 for performing support operations, in accordance with various embodiments. The cell sorter support module 1300 may be implemented by circuitry (e.g., including electrical and/or optical components), such as a programmed computing device. The logic of the cell sorter support module 1300 may be included in a single computing device or may be distributed across multiple computing devices that are in communication with each other as appropriate. Examples of computing devices that may, singly or in combination, implement the cell sorter support module 1300 are discussed herein with reference to the computing device 4000 of FIG. 4, and examples of systems of interconnected computing devices, in which the cell sorter support module 1300 may be implemented across one or more of the computing devices, is discussed herein with reference to the cell sorter support system 5000 of FIG. 5.

The cell sorter support module 1300 may include first determining logic 1302, first receiving logic 1304, second determining logic 1306, training logic 1308, and causing logic 1310. As used herein, the term “logic” may include an apparatus that is to perform a set of operations associated with the logic. For example, any of the logic elements included in the support module 1300 may be implemented by one or more computing devices programmed with instructions to cause one or more processing devices of the computing devices to perform the associated set of operations. The one or more computing devices can include, for example, one or more FPGAs. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The first determining logic 1302 may determine, based on user input, one or more configuration parameters for training machine learning for an instrument device. The configuration parameters may include one or more parameters specifying the machine learning model structure. For example, one or more parameters may include specifying the neural network depth, the neural network/layer size, the activation function, and the like. The neural network depth can include 1 hidden layer, 2 hidden layers, 3 hidden layers, 4 hidden layers, 5 hidden layers, 6 hidden layers, and so on. The neural network can include up to 10 hidden layers, up to 100 hidden layers, and the like.

The layer size can include 1 node per layer, 2 nodes per layer, 3 nodes per layer, and so on. The neural network can include up to 10 nodes per layer, up to 100 nodes per layer, and the like. The number of nodes per layer may or may not be consistent between layers. The activation function can be selected from one or more activation function including for example a binary step function, a linear activation function, a sigmoid/logistic activation function, the derivative of a sigmoid activation function, a Tanh Function (hyperbolic tangent), a gradient of the Tanh activation function, a rectified linear unit (ReLu) activation function, a hard sigmoid function, a leaky ReLu function, other nonlinear activation function, or one or more combinations thereof.

The configuration parameters may include one or more training and/or optimization parameters. The training and/or optimization parameters may include one or more specific distance metrics, loss functions, optimization algorithms and their hyperparameters, learning rate, regularizations terms, instructions for dropout layer usage, early stopping decision parameters and thresholds on accuracy or one or more combinations thereof including one or more other metrics for the trained network to be deemed useable.

The configuration parameters may include one or more preprocessing instructions for the data used in the machine learning algorithm. The one or more preprocessing instructions may include data selection methods such as gating threshold values, fluorescence intensity cutoff values, selection of specific measurements to use as inputs for the machine learning algorithm, and/or one or more combinations thereof. The one or more preprocessing instructions may also include applying one or more scaling functions and associated parameters. The one or more scaling functions may include one or more biexponential, logicle, log, and/or hyperlog transformations.

The configuration parameters may include selecting computing hardware on which computations required for training the machine learning algorithm will be performed. The computing hardware may include but not be limited to a CPU, GPU or other suitable computing system as understood in the art.

The first receiving logic 1304 may receive first cell sorter data from a cell sorter device. The cell sorter data may be received in the form of fluorescence signal data, light scatter data, and/or a combination thereof. The fluorescence signal may be obtained from one or more cells in a sample. The cell sorter data may include quantitative fluorescence data expressed as one or more of antibodies bound per cell, antibody binding capacity (ABC), molecules of equivalent soluble fluorochrome (MESF), one or more other quantitative indicators of fluorescence, or one or more combinations thereof.

The second determining logic 1306 may determine, based on applying a mapping process to the first cell sorter data, a first representation of the first cell sorter data. The mapping process may include one or more of a clustering process, a dimensionality reduction process, an embedding, a non-parametric embedding, or one or more combinations thereof. The embedding may include a uniform Manifold Approximation and Projection (UMAP) a t-distributed Stochastic Neighbor Embedding (t-SNE), or other nonlinear embedding, or a combination thereof. The representation may include one or more clusters of data for separating into subsequent representations of data. The representation of the data may be in the form of a two-dimensional plot, a three-dimensional plot, and/or a combination thereof.

The training logic 1308 may train a machine learning model based on the first cell sorter data and a first representation of the first cell sorter data. The machine learning model may include a neural network trained to learn the mechanism of the mapping process for generating one or more representations of the data for a cell sorter measurement session. The neural network can be trained without prior determination of a first representation of the first cell sorter data in a manner yielding both a representation of the first cell sorter data and a trained neural network generating the representation of the first cell sorter data. The neural network may include one or more of an artificial neural network, a convolutional neural network, a recurrent neural network, or one or more combinations thereof.

The causing logic 1310 may cause storage of the machine learning model, wherein a computer processor, for example an FPGA, in communication with the instrument device is configured to use the stored machine learning model to analyze second cell sorter data received from the instrument device.

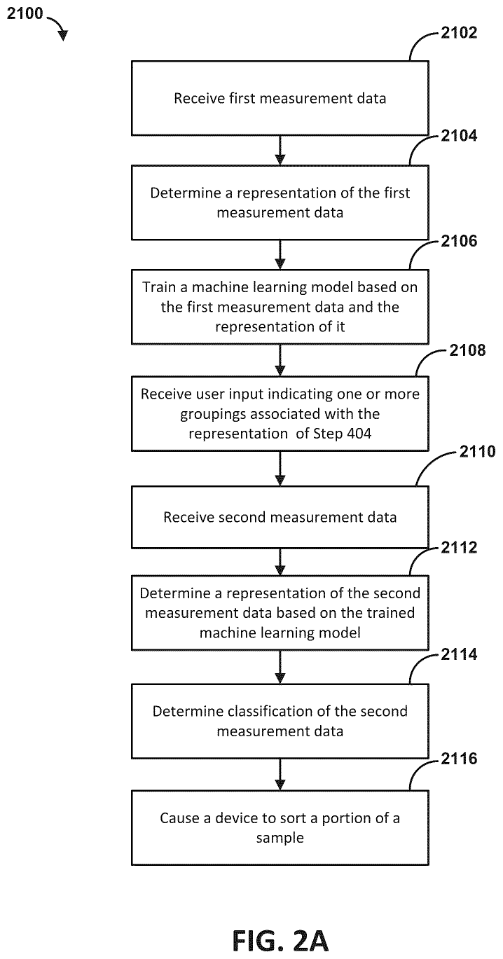

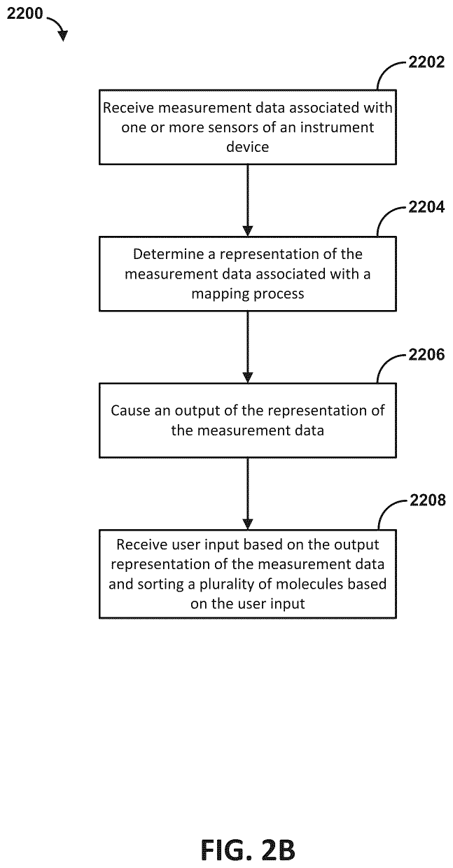

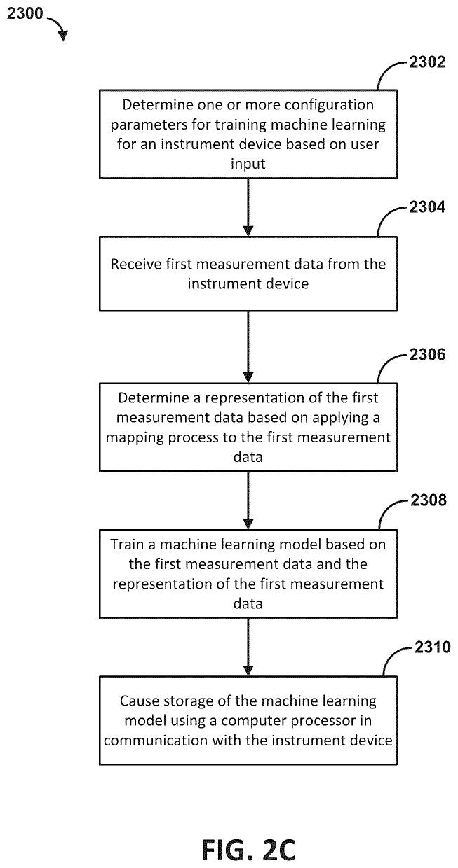

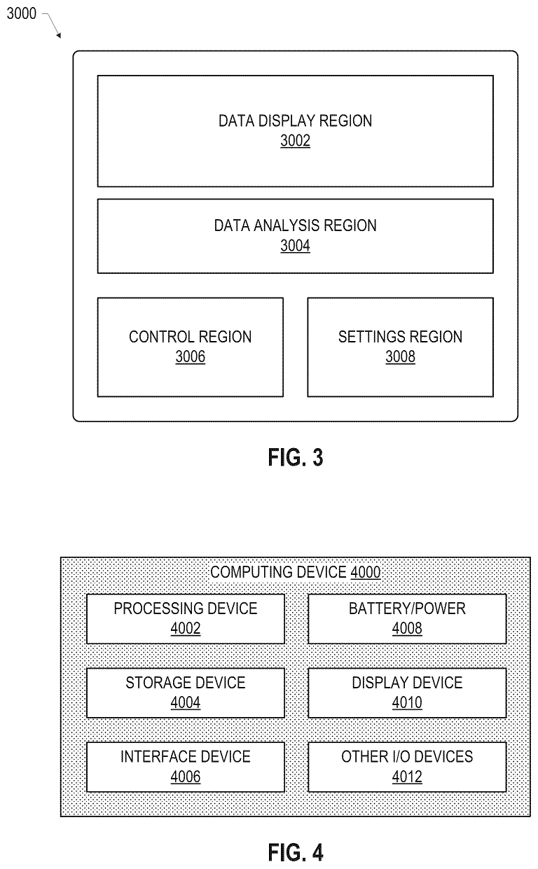

FIG. 2A is a flow diagram of a method 2100 of performing support operations, in accordance with various embodiments. Although the operations of the method 2100 may be illustrated with reference to particular embodiments disclosed herein (e.g., the cell sorter support modules 1000 discussed herein with reference to FIGS. 1A, 1B and 1C, the GUI 3000 discussed herein with reference to FIG. 3, the computing devices 4000 discussed herein with reference to FIG. 4, and/or the cell sorter support system 5000 discussed herein with reference to FIG. 5), the method 2100 may be used in any suitable setting to perform any suitable support operations. Operations are illustrated once each and in a particular order in FIG. 2, but the operations may be reordered and/or repeated as desired and appropriate. For example, different operations performed may be performed in parallel, as suitable.

At 2102, first operations may be performed. For example, the first logic 1102 of a support module 1100 may perform the operations of 2102. The first operations may include receiving first cell sorter data.

At 2104, second operations may be performed. For example, the second logic 1104 of a support module 1100 may perform the operations of 2104. The second operations may include determining a representation of the first cell sorter data.

At 2106, third operations may be performed. For example, the third logic 1106 of a support module 1100 may perform the operations of 2106. The third operations may include training a machine learning model based on the first cell sorter data and a first representation of the first cell sorter data. The machine learning model can include a neural network. The neural network can be trained without prior determination of the representation of the first cell sorter data in a manner yielding both a representation of the first cell sorter data and a trained neural network generating the representation of the first cell sorter data.

At 2108, fourth operations may be performed. For example, the fourth logic 1108 of a support module 1100 may perform the operations of 2108. The third operations may include receiving second cell sorter data.

At 2110, fifth operations may be performed. For example, the fifth logic 1110 of a support module 1100 may perform the operations of 2110. The fifth operations may include determining a representation of the second cell sorter data based on the trained machine learning model.

At 2112, sixth operations may be performed. For example, the sixth logic 1112 of a support module 1100 may perform the operations of 2112. The sixth operations may include receiving user input indicating one or more grouping associated with the representation of the second cell sorter data.

At 2114, seventh operations may be performed. For example, the seventh logic 1114 of a support module 1100 may perform the operations of 2114. The sixth operations may include determining classification of the second cell sorter data.

At 2116, eighth operations may be performed. For example, the eighth logic 1116 of a support module 1100 may perform the operations of 2116. The eighth operations may include causing a device to sort a portion of a sample.

FIG. 2B is a flow diagram of a method 2200 of performing support operations, in accordance with various embodiments. Although the operations of the method 2200 may be illustrated with reference to particular embodiments disclosed herein (e.g., the cell sorter support modules 1100-1300 discussed herein with reference to FIGS. 1A, 1B and 1C, the GUI 3000 discussed herein with reference to FIG. 3, the computing devices 4000 discussed herein with reference to FIG. 4, and/or the cell sorter support system 5000 discussed herein with reference to FIG. 5), the method 2200 may be used in any suitable setting to perform any suitable support operations. Operations are illustrated once each and in a particular order in FIG. 2B, but the operations may be reordered and/or repeated as desired and appropriate. For example, different operations performed may be performed in parallel, as suitable).

At 2202, first operations may be performed. For example, the first logic 1202 of a support module 1200 may perform the operations of 2202. The first operations may include receiving cell sorter data associated with one or more sensors of an instrument device.

At 2204, second operations may be performed. For example, the second logic 1204 of a support module 1200 may perform the operations of 2204. The second operations may include determining a representation of the cell sorter data associated with a mapping process. The representation may be generated by the machine learning model without prior knowledge of the first representation data. The representation may be generated by the trained machine learning model.

At 2206, third operations may be performed. For example, the third logic 1206 of a support module 1200 may perform the operations of 2206. The third operations may include causing an output of the representation of the cell sorter data.

At 2208, fourth operations may be performed. For example, the fourth logic 1208 of a support module 1200 may perform the operations of 2208. The fourth operations may include receiving user input based on the output representation of the cell sorter data and sorting a plurality of particles based on the user input.

FIG. 2C is a flow diagram of a method 2300 of performing support operations, in accordance with various embodiments. Although the operations of the method 2300 may be illustrated with reference to particular embodiments disclosed herein (e.g., the cell sorter support modules 1100-1300 discussed herein with reference to FIGS. 1A, 1B and 1C, the GUI 3000 discussed herein with reference to FIG. 3, the computing devices 4000 discussed herein with reference to FIG. 4, and/or the cell sorter support system 5000 discussed herein with reference to FIG. 5), the method 2300 may be used in any suitable setting to perform any suitable support operations. Operations are illustrated once each and in a particular order in FIG. 2C, but the operations may be reordered and/or repeated as desired and appropriate (e.g., different operations performed may be performed in parallel, as suitable).

At 2302, first operations may be performed. For example, the first logic 1302 of a support module 1300 may perform the operations of 2302. The first operations may include determining one or more configuration parameters for training machine learning for an instrument based on user input.

At 2304, second operations may be performed. For example, the second logic 1304 of a support module 1300 may perform the operations of 2304. The second operations may include receiving first cell sorter data from the instrument device.

At 2306, third operations may be performed. For example, the third logic 1306 of a support module 1300 may perform the operations of 2306. The third operations may include determining a representation of the first cell sorter data based on applying a mapping process to the first cell sorter data.

At 2308, fourth operations may be performed. For example, the fourth logic 1308 of a support module 1300 may perform the operations of 2308. The fourth operations may include training a machine learning model based on the first cell sorter data and a first representation of the first cell sorter data. The fourth operations may include training a machine learning model to determine a representation of the first cell sorter data without prior determination of a representation of the first cell sorter data. The machine learning model can include a neural network. The neural network can be trained without prior determination of the representation of the first cell sorter data in a manner yielding both a representation of the first cell sorter data and a trained neural network generating the representation of the first cell sorter data. The representation can include an embedding.

At 2310, fifth operations may be performed. For example, the fifth logic 1310 of a support module 1300 may perform the operations of 2310. The fifth operations may include causing storage of the machine learning model using a computer processor in communication with the instrument device.

The cell sorter support methods disclosed herein may include interactions with a human user (e.g., via the user local computing device 5020 discussed herein with reference to FIG. 5). These interactions may include providing information to the user (e.g., information regarding the operation of a cell sorter such as the cell sorter 5010 of FIG. 5, information regarding a sample being analyzed or other test or measurement performed by a cell sorter, information retrieved from a local or remote database, or other information) or providing an option for a user to input commands (e.g., to control the operation of a cell sorter such as the cell sorter 5010 of FIG. 5, or to control the analysis of data generated by a cell sorter), queries (e.g., to a local or remote database), or other information. In some embodiments, these interactions may be performed through a graphical user interface (GUI) that includes a visual display on a display device (e.g., the display device 4010 discussed herein with reference to FIG. 4) that provides outputs to the user and/or prompts the user to provide inputs (e.g., via one or more input devices, such as a keyboard, mouse, trackpad, or touchscreen, included in the other I/O devices 4012 discussed herein with reference to FIG. 4). The cell sorter support systems disclosed herein may include any suitable GUIs for interaction with a user. In some embodiments, the visual display includes one or more representations of cell sorter data. The one or more representations can include at least one two-dimensional or three-dimensional plot. In some embodiments, the one or more representations are generated in real-time.

FIG. 3 depicts an example GUI 3000 that may be used in the performance of some or all of the support methods disclosed herein, in accordance with various embodiments. As noted above, the GUI 3000 may be provided on a display device (e.g., the display device 4010 discussed herein with reference to FIG. 4) of a computing device (e.g., the computing device 4000 discussed herein with reference to FIG. 4) of a cell sorter support system (e.g., the cell sorter support system 5000 discussed herein with reference to FIG. 5), and a user may interact with the GUI 3000 using any suitable input device (e.g., any of the input devices included in the other I/O devices 4012 discussed herein with reference to FIG. 4) and input technique (e.g., movement of a cursor, motion capture, facial recognition, gesture detection, voice recognition, actuation of buttons, etc.).

The GUI 3000 may include a data display region 3002, a data analysis region 3004, a cell sorter control region 3006, and a settings region 3008. The particular number and arrangement of regions depicted in FIG. 3 is simply illustrative, and any number and arrangement of regions, including any desired features, may be included in a GUI 3000.

The data display region 3002 may display data generated by a cell sorter including, for example, the cell sorter 5010 discussed herein with reference to FIG. 5. For example, the data display region 3002 may display ranges of fluorescence intensities, gating information, clustering information, and the like.

The data analysis region 3004 may display the results of data analysis including, for example, the results of analyzing the data illustrated in the data display region 3002 and/or other data. For example, the data analysis region 3004 may display one or more representations of cell sorter data. In some embodiments, the data display region 3002 and the data analysis region 3004 may be combined in the GUI 3000, for example, to include data output from a cell sorter, and some analysis of the data, in a common graph or region).

The cell sorter control region 3006 may include options that allow the user to control a cell sorter, for example, the cell sorter 5010 discussed herein with reference to FIG. 5). For example, the cell sorter control region 3006 may include one or more user interfaces for receiving user input. The user input may include assigning a gating threshold based on the cell sorter data. The assigned gating threshold can include gating instructions provided by the user including drawing a gate on a parametric embedding based on the cell sorter data. The user input may be assigning a fluorophore to a channel and/or assigning a cell marker to a fluorophore. The user input may also include control parameters for the instrument's fluidic system, electronic system, mechanical system and the like. The control parameters may include user specified values for one or more parameters including event rate, PMT voltage, and the like.

The user input may further include specifying one or more parameters associated with one or more physical devices and/or modalities for sorting a sample of cells. For example, the user input can include specifying the one or more receiving containers for collecting the one or more sorted distinct cell populations. The one or more receiving containers can include one or more tubes with a specified volume, one or more plates with a specified number of wells, and the like. The user input can also include specifying the desired number of cells received or to be received within each receiving container. The user input can also include specifying the direction of waste stream.

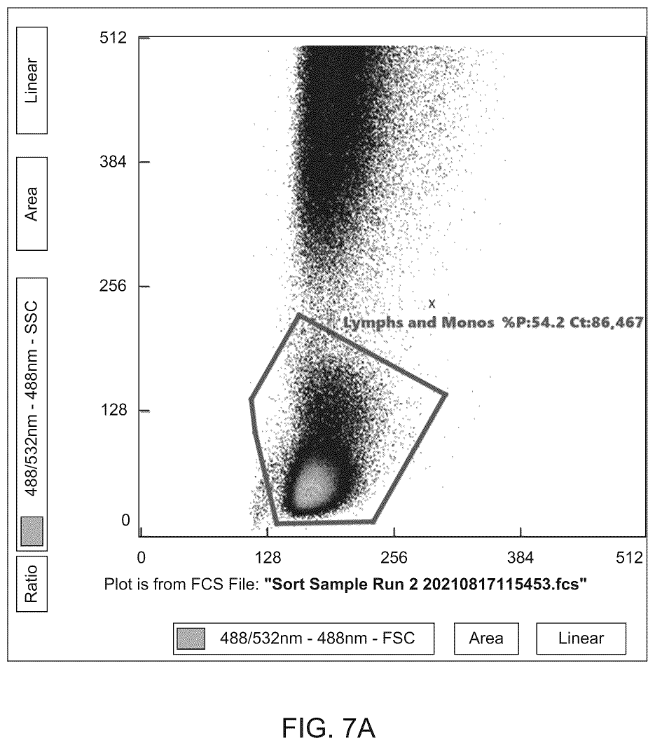

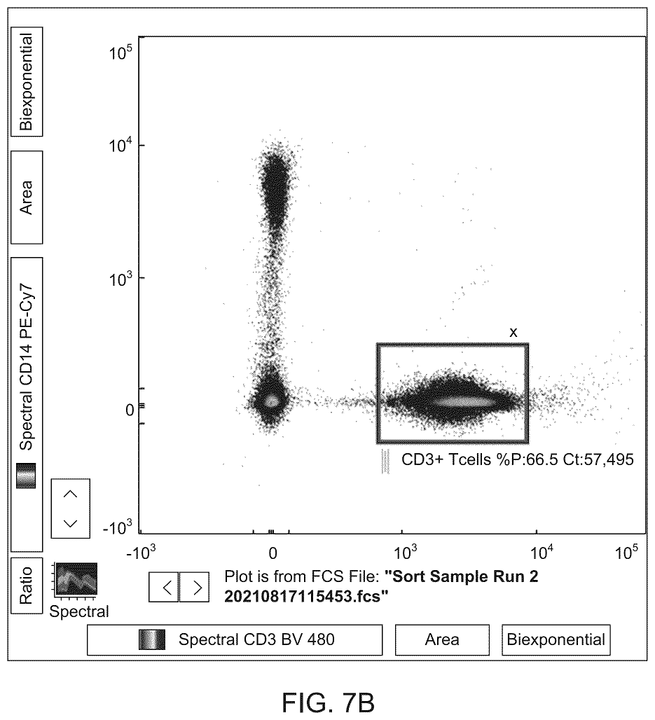

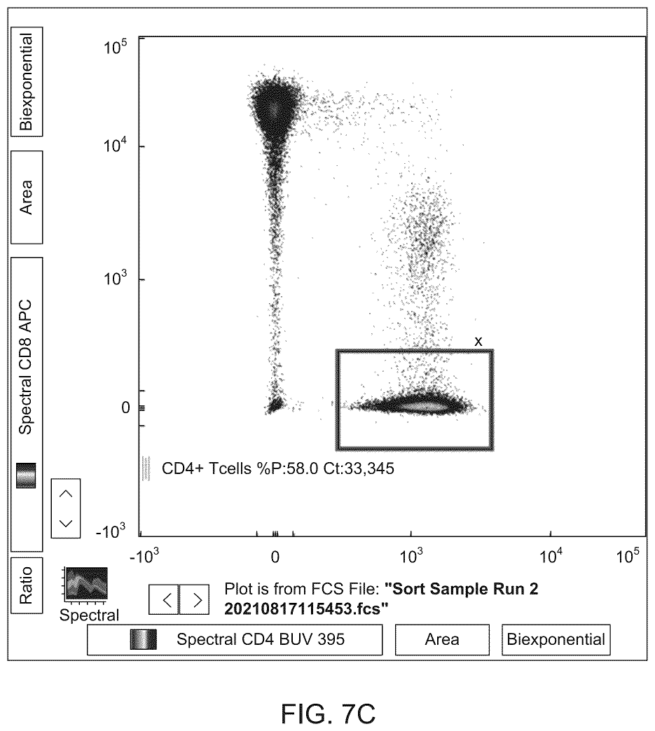

The user input can include gating instructions including specifying one or more gating threshold values. The one or more gating instructions can be determined based on one or more of fluorescence data, light scatter data, fluorescent marker expression level data, data output from the machine learning model, an embedding output from the machine learning model, a parametric embedding of the cell sorting data generated using the machine learning model, or a combination thereof. The one or more gating threshold values or gates may be used as preprocessing for the machine learning model. In some embodiments, one or more traditional gating schemes may be used in tandem with one or more gates used in the machine learning model. For example, a first gates may be specified and/or applied to distinguish single cells from clusters of cells and another gate may be specified and/or applied based on the machine learned representation of the data. The user input applied to one or more sorting decision pathways can include specifying that information is used from one or more traditional representations of the data, one or more machine learned representations of the data, and/or from both traditional and machine learned representations of the data. FIGS. 7A, 7B and 7C show an example of a traditional user drawn gating scheme based on fluorescent marker expression levels of the first cell sorter data.

The settings region 3008 may include options that allow the user to control the features and functions of the GUI 3000 (and/or other GUIs) and/or perform common computing operations with respect to the data display region 3002 and data analysis region 3004 (e.g., saving data on a storage device, such as the storage device 4004 discussed herein with reference to FIG. 4, sending data to another user, labeling data, etc.). For example, the settings region 3008 may include one or more options for setting one or more display parameters. The one or more display parameters may include setting one or more scaling functions for data visualization such as applying upper or lower limits on one or more display plot axes. The one or more display parameters may also include setting one or more data storage formatting parameters. The one or more display parameters may also include setting one or more parameters for exporting data, saving data, exporting one or more models, and the like. The computer operations may be performed using, for example, a FPGA.

As noted above, the cell sorter support module 1000 may be implemented by one or more computing devices. FIG. 4 is a block diagram of a computing device 4000 that may perform some or all of the cell sorter support methods disclosed herein, in accordance with various embodiments. In some embodiments, the cell sorter support module 1000 may be implemented by a single computing device 4000 or by multiple computing devices 4000. Further, as discussed below, a computing device 4000 (or multiple computing devices 4000) that implements the cell sorter support module 1000 may be part of one or more of the cell sorter 5010, the user local computing device 5020, the service local computing device 5030, or the remote computing device 5040 of FIG. 5. The computing device can include, for example, an FPGA.

The computing device 4000 of FIG. 4 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 4, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry, for example, a connector and driver circuitry, to which a display device 4010 may be coupled.

The computing device 4000 may include a processing device 4002. The processing device may include one or more processing devices. As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), field programmable gate arrays (FPGAs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 may include a storage device 4004. The storage device may include one or more storage devices. The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random access memory (eDRAM) or spin transfer torque magnetic random access memory (STT-MRAM), for example. In some embodiments, the storage device 4004 may include non-transitory computer readable media having instructions thereon that, when executed by one or more processing devices including, for example, the processing device 4002, cause the computing device 4000 to perform any appropriate ones of or portions of the methods disclosed herein.

The computing device 4000 may include an interface device 4006. The interface device may include one or more interface devices 4006. The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or Bluetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices including batteries or capacitors, and/or circuitry for coupling components of the computing device 4000 to an energy source separate from the computing device 4000 such as an AC line power.

The computing device 4000 may include a display device 4010. The display device may include multiple display devices. The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices such as speakers, headsets, earbuds, alarms, etc., and the like, one or more audio input devices such as microphones or microphone arrays, location devices such as GPS devices in communication with a satellite-based system to receive a location of the computing device 4000, as known in the art, audio codecs, video codecs, printers, sensors such as thermocouples or other temperature sensors, humidity sensors, pressure sensors, vibration sensors, accelerometers, gyroscopes, etc., image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device such as, for example, a cell phone, a smart phone, a mobile internet device, a tablet computer, a laptop computer, a netbook computer, an ultrabook computer, a personal digital assistant (PDA), an ultra mobile personal computer, etc., a desktop computing device, or a server computing device or other networked computing component.

One or more computing devices implementing any of the cell sorter support modules or methods disclosed herein may be part of a cell sorter support system. FIG. 5 is a block diagram of an example cell sorter support system 5000 in which some or all of the cell sorter support methods disclosed herein may be performed, in accordance with various embodiments. The cell sorter support modules and methods disclosed herein, including the cell sorter support modules 1100-1300 of FIGS. 1A-1C and the method 2000 of FIG. 2, may be implemented by one or more of the cell sorter 5010, the user local computing device 5020, the service local computing device 5030, or the remote computing device 5040 of the cell sorter support system 5000.

Any of the cell sorter 5010, the user local computing device 5020, the service local computing device 5030, or the remote computing device 5040 may include any of the embodiments of the computing device 4000 discussed herein with reference to FIG. 4, and any of the cell sorter 5010, the user local computing device 5020, the service local computing device 5030, or the remote computing device 5040 may take the form of any appropriate ones of the embodiments of the computing device 4000 discussed herein with reference to FIG. 4.

The cell sorter 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 4, and the processing devices 5002 included in different ones of the cell sorter 5010, the user local computing device 5020, the service local computing device 5030, or the remote computing device 5040 may take the same form or different forms. The storage device 5004 may take any suitable form, including the form of any of the storage devices 5004 discussed herein with reference to FIG. 4, and the storage devices 5004 included in different ones of the cell sorter 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 4, and the interface devices 5006 included in different ones of the cell sorter 5010, the user local computing device 5020, the service local computing device 5030, or the remote computing device 5040 may take the same form or different forms.

The cell sorter 5010, the user local computing device 5020, the service local computing device 5030, and the remote computing device 5040 may be in communication with other elements of the cell sorter support system 5000 via communication pathways 5008. The communication pathways 5008 may communicatively couple the interface devices 5006 of different ones of the elements of the cell sorter support system 5000, as shown, and may be wired or wireless communication pathways (e.g., in accordance with any of the communication techniques discussed herein with reference to the interface devices 4006 of the computing device 4000 of FIG. 4). The particular cell sorter support system 5000 depicted in FIG. 5 includes communication pathways between each pair of the cell sorter 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the cell sorter 5010, but may instead communicate with the cell sorter 5010 via the communication pathway 5008 between the service local computing device 5030 and the user local computing device 5020 and the communication pathway 5008 between the user local computing device 5020 and the cell sorter 5010. The cell sorter 5010 may include any appropriate cell sorter, such as a BIGFOOT™ Spectral Cell Sorter.

The user local computing device 5020 may be a computing device (e.g., in accordance with any of the embodiments of the computing device 4000 discussed herein) that is local to a user of the cell sorter 5010. In some embodiments, the user local computing device 5020 may also be local to the cell sorter 5010, but this need not be the case; for example, a user local computing device 5020 that is in a user's home or office may be remote from, but in communication with, the cell sorter 5010 so that the user may use the user local computing device 5020 to control and/or access data from the cell sorter 5010. In some embodiments, the user local computing device 5020 may be a laptop, smartphone, or tablet device. In some embodiments the user local computing device 5020 may be a portable computing device.

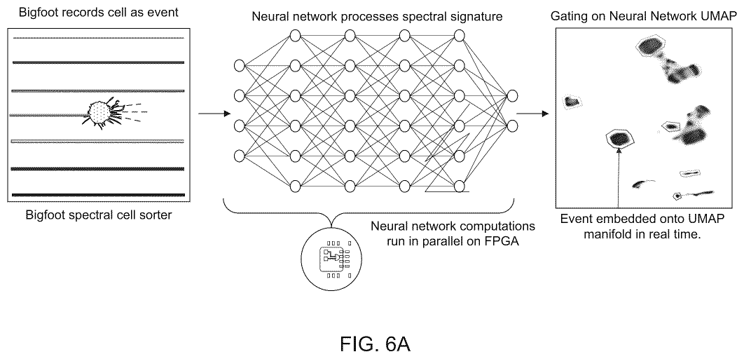

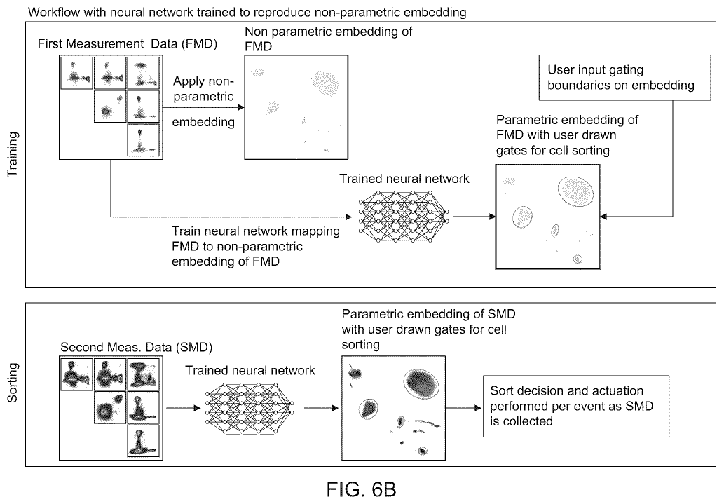

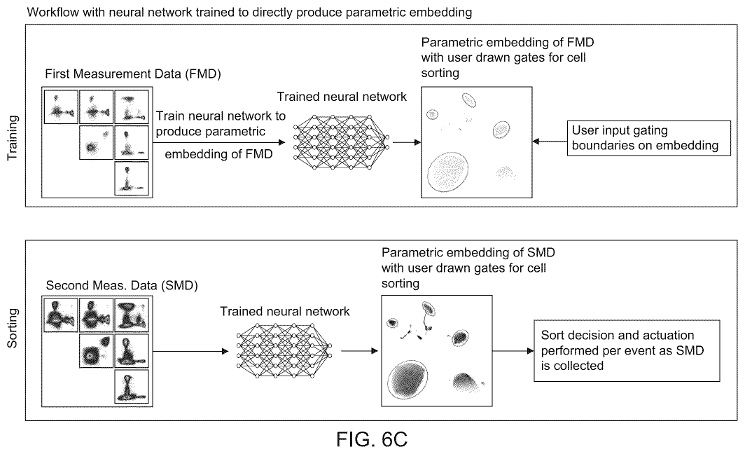

FIGS. 6A, 6B and 6C show exemplary workflow using a spectral cell sorting device, processing the cell sorter spectral signature data using a neural network. In the workflow shown in FIG. 6A, a cell passes through a linear array of lasers, creating fluorescence scatter from each one. This fluorescence intensity is converted to digital signals via the cell sorter's optical and PMT arrays. The network is presented with this data and the onboard FPGA processes the cell through the neural network. In some embodiments preprocessing operations such as scaling or spectral unmixing may or may not be carried out on the FPGA prior to data entering the neural network. This information is passed to the software which can plot the resulting 2D output or representation onto the original visualization. In order to sort the cell based on these operations, the cell sorting instrumentation must make a sort decision in as little as 300 μs of the cell being interrogated by the lasers. An FPGA-based architecture implemented in the cell sorter allows for precise timing of mathematical operations as is required by high-throughput cell sorters. In some embodiments, the architecture allows for operations at an event rate of up to 100,000 cells per second. In some embodiments, the architecture allows for operations at an event rate of greater than about 100,000 cells per second. In the workflow shown in FIG. 6B, the first step is finding a non-parametric embedding. The neural network is then trained to reproduce the non-parametric embedding from the first cell sorter data. This is a standard supervised learning problem and may be done using methods such as minimizing the mean square error using an optimizer such as Adam. After training the neural network, the first cell sorter data can be passed through the network to produce a parametric embedding of the first cell sorter data. The parametric embedding can include an approximation of an original non-parametric embedding. In the workflow shown in FIG. 6C, the network is trained directly to produce a parametric embedding. In both of the workflows shown in FIGS. 6B and 6C, users will see the parametric embedding of the first cell sorter data and specify gates on that representation for sorting. The user may provide gating instructions including specifying one or more collections of sorting gates. The gates can be determined using one or more of the measured fluorescence, light scatter data, the fluorescent marker expressions levels, the parametric embedding and the like. The neural network (including trained weights) and gates can be stored on the instrument's FPGA for use in sorting cells corresponding to the second cell sorter data. That is, the stored neural network and gates are used to sort a second portion of cells in the sample that correspond to the second cell sorter data.

FIGS. 7A, 7B and 7C show exemplary cell sorter data obtained using current accepted analysis methods. The flow data is shown as a series of two-dimensional plots with a set of exclusionary gates that isolate a desired cell population based on expression levels of fluorescent markers.

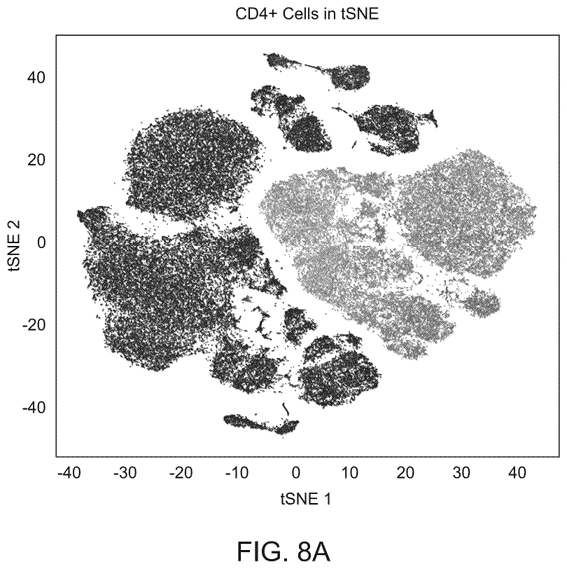

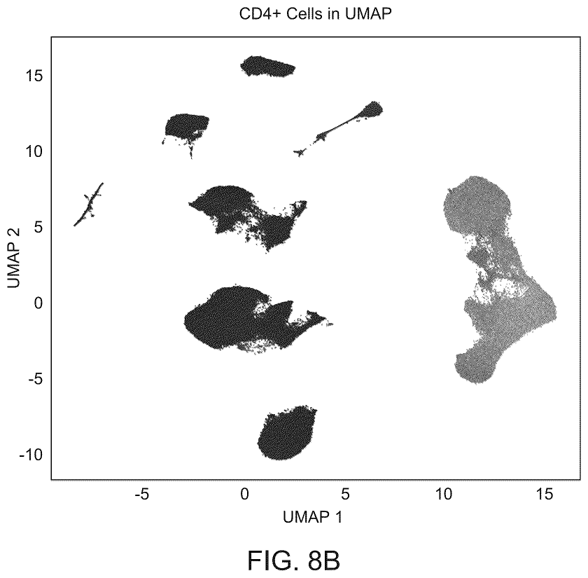

FIGS. 8A and 8B show plots where CD4+ T cells are highlighted in both a tSNE and UMAP embedding. It is immediately clear that there are multiple populations within the CD4+ subset. This may not be revealed in the classic gating approach. For example, in some cases there will be multiple CD4+ populations made distinct by expression level of the other marker used in a two-dimensional plot. For example, a single plot used in a traditional gating scheme could reveal both CD4+/CD8+ and CD4+/CD8− populations.

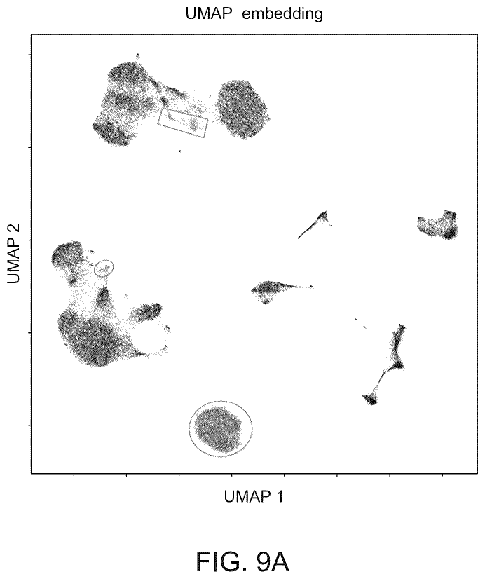

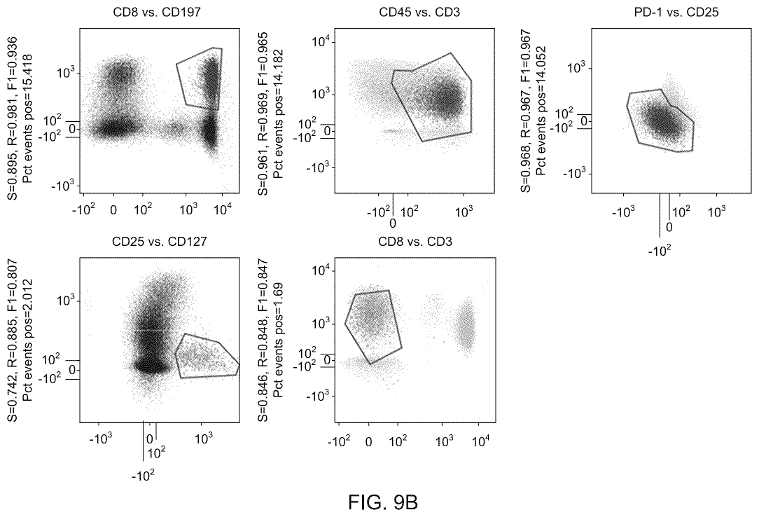

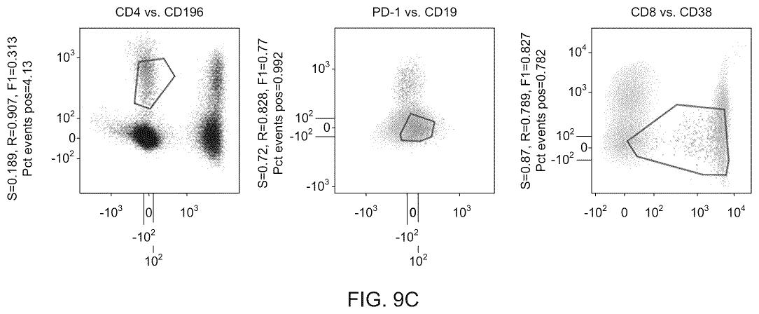

FIGS. 9A to 9C depict sequences of gates formed via a gate-finding algorithm prototypical to those that may be used in combination with methods of the present disclosure. To provide information about the content of each cluster, a gate-finding algorithm was developed. This allows the user to enclose any cluster in their embedding and see a familiar set of gates that isolate their cells of interest.

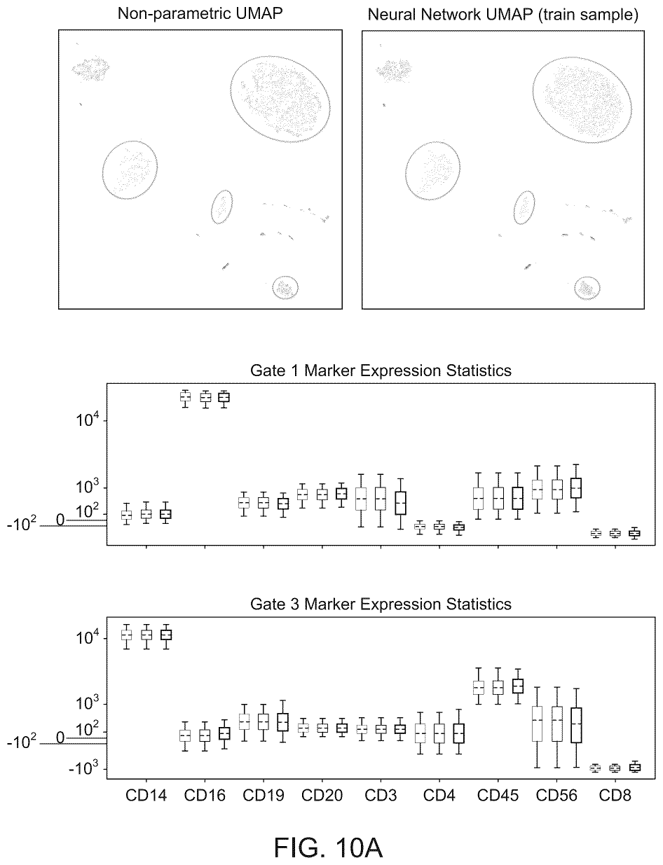

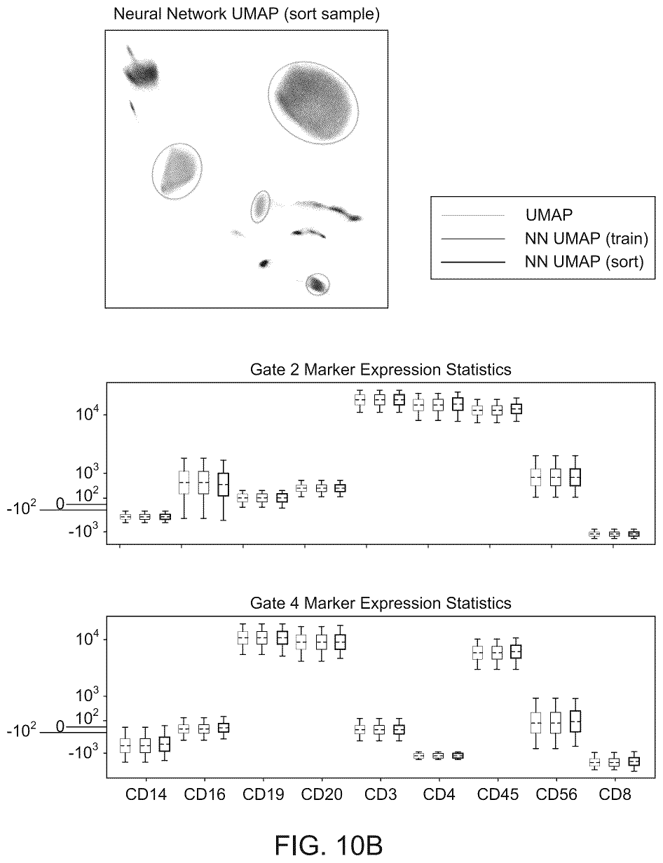

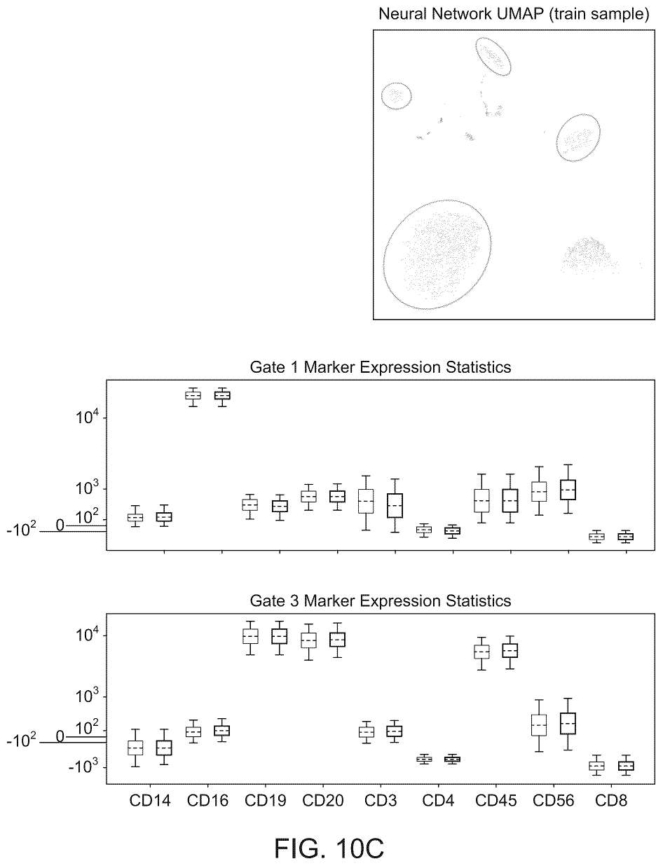

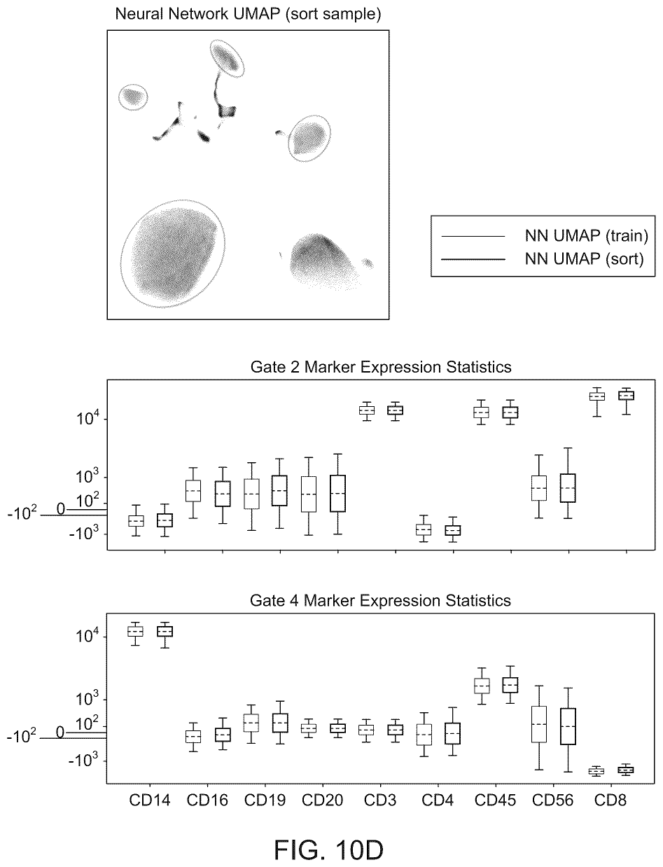

FIGS. 10A to 10D show data obtained at steps of the methods of the present disclosure. In FIGS. 10A and 10B, a first UMAP was performed on a small subset of the fully mixed sample. This mapping was used to train a neural network to learn the mechanisms of the embedding. In FIGS. 10C and 10D, a neural network was trained to produce a parametric UMAP embedding without prior determination of the UMAP embedding. Prototype networks using 9 hidden layers of size 64 yielded high-fidelity reconstructions of the clusters and topological features that were observed in traditional UMAP. With these two tools in place, a user can gate on any cluster in their embedding, get a complete understanding of what is in that cluster, and model new cells into their embedding in real time.

The user local computing device 5020 may be a computing device (e.g., in accordance with any of the embodiments of the computing device 4000 discussed herein) that is local to a user of the cell sorter 5010. In some embodiments, the user local computing device 5020 may also be local to the cell sorter 5010, but this need not be the case; for example, a user local computing device 5020 that is in a user's home or office may be remote from, but in communication with, the cell sorter 5010 so that the user may use the user local computing device 5020 to control and/or access data from the cell sorter 5010. In some embodiments, the user local computing device 5020 may be a laptop, smartphone, or tablet device. In some embodiments the user local computing device 5020 may be a portable computing device. In some embodiments, the user local computing device 5020 may include one or more hardware components for performing computations including a CPU, GPU, TPU, or other suitable processor or computing device.

The service local computing device 5030 may be a computing device, for example, in accordance with any of the embodiments of the computing device 4000 discussed herein, that is local to an entity that services the cell sorter 5010. For example, the service local computing device 5030 may be local to a manufacturer of the cell sorter 5010 or to a third-party service company. In some embodiments, the service local computing device 5030 may communicate with the cell sorter 5010, the user local computing device 5020, and/or the remote computing device 5040 such as via a direct communication pathway 5008 or via multiple “indirect” communication pathways 5008, as discussed above, to receive data regarding the operation of the cell sorter 5010, the user local computing device 5020, and/or the remote computing device 5040 (e.g., the results of self-tests of the cell sorter 5010, calibration coefficients used by the cell sorter 5010, the measurements of sensors associated with the cell sorter 5010, etc.). In some embodiments, the service local computing device 5030 may communicate with the cell sorter 5010, the user local computing device 5020, and/or the remote computing device 5040 such as via a direct communication pathway 5008 or via multiple “indirect” communication pathways 5008, as discussed above to transmit data to the cell sorter 5010, the user local computing device 5020, and/or the remote computing device 5040, for example, to update programmed instructions, such as firmware, in the cell sorter 5010, to initiate the performance of test or calibration sequences in the cell sorter 5010, to update programmed instructions, such as software, in the user local computing device 5020 or the remote computing device 5040, etc. A user of the cell sorter 5010 may utilize the cell sorter 5010 or the user local computing device 5020 to communicate with the service local computing device 5030 to report a problem with the cell sorter 5010 or the user local computing device 5020, to request a visit from a technician to improve the operation of the cell sorter 5010, to order consumables or replacement parts associated with the cell sorter 5010, or for other purposes.

The remote computing device 5040 may be a computing device (e.g., in accordance with any of the embodiments of the computing device 4000 discussed herein) that is remote from the cell sorter 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the cell sorter 5010, perform analyses of the data generated by the cell sorter 5010 (e.g., in accordance with programmed instructions), facilitate communication between the user local computing device 5020 and the cell sorter 5010, and/or facilitate communication between the service local computing device 5030 and the cell sorter 5010.

In some embodiments, one or more of the elements of the cell sorter support system 5000 illustrated in FIG. 5 may not be present. Further, in some embodiments, multiple ones of various ones of the elements of the cell sorter support system 5000 of FIG. 5 may be present. For example, a cell sorter support system 5000 may include multiple user local computing devices 5020 (e.g., different user local computing devices 5020 associated with different users or in different locations). In another example, a cell sorter support system 5000 may include multiple cell sorters 5010, all in communication with service local computing device 5030 and/or a remote computing device 5040; in such an embodiment, the service local computing device 5030 may monitor these multiple cell sorters 5010, and the service local computing device 5030 may cause updates or other information may be “broadcast” to multiple cell sorters 5010 at the same time. Different ones of the cell sorters 5010 in a cell sorter support system 5000 may be located close to one another (e.g., in the same room) or farther from one another (e.g., on different floors of a building, in different buildings, in different cities, etc.). In some embodiments, a cell sorter 5010 may be connected to an Internet-of-Things (IoT) stack that allows for command and control of the cell sorter 5010 through a web-based application, a virtual or augmented reality application, a mobile application, and/or a desktop application. Any of these applications may be accessed by a user operating the user local computing device 5020 in communication with the cell sorter 5010 by the intervening remote computing device 5040. In some embodiments, a cell sorter 5010 may be sold by the manufacturer along with one or more associated user local computing devices 5020 as part of a local cell sorter computing unit 5012.

In some embodiments, different ones of the cell sorters 5010 included in a cell sorter support system 5000 may be different types of cell sorters 5010; for example, one cell sorter 5010 may be a cell sorter while another cell sorter 5010 may be an analyzer with cell sorting capabilities. For example, the cell sorter 5010 can include a flow cytometer with cell sorting capabilities. The cell sorter may be a Fluorescence-activated cell sorting (FACS) system. In some such embodiments, the remote computing device 5040 and/or the user local computing device 5020 may combine data from different types of cell sorters 5010 included in a cell sorter support system 5000.

The following paragraphs provide various examples of the embodiments disclosed herein. Example 1 is a system comprising: a cell sorting device, and a computing device configured to perform the steps of: collecting first cell sorter data associated with a first portion of a sample of one or more cells; training, based on one or more of the first cell sorter data, user input, a first representation of the first cell sorter data or a combination thereof, a machine learning model; receiving one or more gating instructions from a user input based on the first cell sorter data, the machine learning model, or a combination thereof; receiving second cell sorter data associated with a second portion of the sample of one or more cells; determining, based on the trained machine learning model and the user-inputted gating instructions, a classification of the second cell sorter data, a representation of the second cell sorter data, or a combination thereof; and sorting, based on the classification, a portion of the sample.

Example 2 is a method of sorting a sample of particles, the method comprising: collecting first cell sorter data associated with a first portion of a sample of one or more particles comprising cells; training, based on one or more of the first cell sorter data, user input, a first representation of the first cell sorter data or a combination thereof, a machine learning model; receiving one or more gating instructions from a user input based on the first cell sorter data, the machine learning model, or a combination thereof; receiving second cell sorter data associated with a second portion of the sample of one or more cells; determining, based on the trained machine learning model and the user-inputted gating instructions, a classification of the second cell sorter data, a representation of the second cell sorter data, or a combination thereof; and sorting, based on the classification, a portion of the sample.

Example 3 may include the subject matter of Example 2 and may further specify the one or more gating instructions are determined based on one or more of data output from the machine learning model, an embedding output from the machine learning model, a parametric embedding of the cell sorter data generated using the machine learning model, or a combination thereof.

Example 4 may include the subject matter of Example 2 and may further specify the user input comprises gating instructions, sorting instructions, or a combination thereof indicating one or more groupings associated with the first cell sorter data.

Example 5 may include the subject matter of Example 4 and may further specify the one or more groupings comprise one or more signal clusterings or gatings for one or more parameters comprising: removal of doublets, cell viability, light scatter, expression of one or more specific lineage markers, or one or more combinations thereof.

Example 6 may include the subject matter of Example 2 and may further specify the cell sorter comprises a field-programmable gate array (FPGA), the FPGA is programmed with parameters of the trained machine learning model and configured to analyze a plurality of portions of the sample using the trained machine learning model, and configured to cause the FPGA to store or comprise one or more trained weights of the trained machine learning model.

Example 7 may include the subject matter of Example 2 and may further specify the first representation of the first cell sorter data is determined based on applying a mapping process to the first cell sorter data, the mapping process comprising one or more of a clustering process, a dimensionality reduction process, an embedding, a non-parametric embedding, or a combination thereof.

Example 8 may include the subject matter of Example 7 and may further specify the embedding comprises a uniform Manifold Approximation and Projection (UMAP), a t-distributed Stochastic Neighbor Embedding (t-SNE), another nonlinear embedding, or a combination thereof.

Example 9 may include the subject matter of Example 2 and may further specify that the machine learning model transforms cell sorter data having a higher number of dimensions to a representation of the transformed cell sorter data having a lower number of dimensions.

Example 10 may include the subject matter of Example 2 and may further specify that the cell sorter data comprises quantitative fluorescence data expressed as one or more of antibodies bound per cell, antibody binding capacity (ABC), or molecules of equivalent soluble fluorochrome (MESF), one or more other quantitative indicators of fluorescence, or one or more combinations thereof.

Example 11 may include the subject matter of claim 10 and may further specify the fluorescence signals are derived from one or more fluorescent proteins, one or more fluorescent dyes, one or more fluorescently conjugate antibodies, one or more populations of fluorescent beads or fluorescently labeled beads, or one or more combinations thereof.

Example 12 may include the subject matter of Example 2 and may further specify the machine learning model comprises a neural network.

Example 13 may include the subject matter of Example 2 and may further specify the machine learning model is trained without prior determination of a first representation of the first cell sorter data.

Example 14 may include the subject matter of Example 12 and may further specify the neural network is trained to learn the mechanism of a mapping process for generating one or more representations of the cell sorter data for a cell sorter measurement session.

Example 15 may include the subject matter of Example 12 any may further specify the neural network comprises one or more of an artificial neural network, a convolutional neural network, a recurrent neural network, or one or more combinations thereof.

Example 16 may include the subject matter of Example 12 and may further specify the neural network processes cell sorter data enabling cell sorting events equal to or greater than 100,000 events per second.

Example 17 may include the subject matter of Example 2 and may further specify the sample comprises a biological sample comprising a plurality of cells.

Example 18 may include the subject matter of Example 2 and may further specify the classification is based on one or more cellular phenotypic markers.

Example 19 may include the subject matter of Example 2 and may further specify the cell sorter comprises one or more processors, wherein the one or more processors pass the classification of the second cell sorter data to the cell sorter for sorting the portion of the sample.

Example 20 is a method for displaying flow-cytometry data in real-time, the method comprising: outputting, via the user interface associated with a cell sorter, a representation of a first portion of a sample; receiving, via a user interface, an instruction to generate a machine learning model for the sample, wherein the machine learning model is trained based on a mapping process for mapping cell sorter data to an embedding space; receiving, via the user interface, an instruction to process a second portion of the sample, wherein the instruction process comprises an instruction to sort the sample using the machine learning model; and outputting, via the user interface and based on the machine learning model, a representation of the second cell sorter data.

What is claimed:

1. A system comprising:
a cell sorting device, and
a computing device configured to perform the steps of:
collecting first cell sorter data associated with a first portion of a sample of one or more cells;
training, based on one or more of the first cell sorter data, user input, a first representation of the first cell sorter data or a combination thereof, a machine learning model;
receiving one or more gating instructions from a user input based on the first cell sorter data, the machine learning model, or a combination thereof;
receiving second cell sorter data associated with a second portion of the sample of one or more cells;
determining, based on the trained machine learning model and the user-inputted gating instructions, a classification of the second cell sorter data, a representation of the second cell sorter data, or a combination thereof; and
sorting, based on the classification, a portion of the sample.

2. A method of sorting a sample of particles, the method comprising:
collecting first cell sorter data associated with a first portion of a sample of one or more particles comprising cells;
training, based on one or more of the first cell sorter data, user input, a first representation of the first cell sorter data or a combination thereof, a machine learning model;
receiving one or more gating instructions from a user input based on the first cell sorter data, the machine learning model, or a combination thereof;
receiving second cell sorter data associated with a second portion of the sample of one or more cells;
determining, based on the trained machine learning model and the user-inputted gating instructions, a classification of the second cell sorter data, a representation of the second cell sorter data, or a combination thereof; and
sorting, based on the classification, a portion of the sample.

3. The method of claim 2, wherein the one or more gating instructions are determined based on one or more of data output from the machine learning model, an embedding output from the machine learning model, a parametric embedding of the cell sorter data generated using the machine learning model, or a combination thereof.

4. The method of claim 2, wherein the user input comprises gating instructions, sorting instructions, or a combination thereof indicating one or more groupings associated with the first cell sorter data.

5. The method of claim 4, wherein the one or more groupings comprise one or more signal clusterings or gatings for one or more parameters comprising: removal of doublets, cell viability, light scatter, expression of one or more specific lineage markers, or one or more combinations thereof.

6. The method of claim 2, wherein the cell sorter comprises a field-programmable gate array (FPGA), wherein the FPGA is programmed with parameters of the trained machine learning model and configured to analyze a plurality of portions of the sample using the trained machine learning model, and configured to cause the FPGA to store or comprise one or more trained weights of the trained machine learning model.

7. The method of claim 2, wherein the first representation of the first cell sorter data is determined based on applying a mapping process to the first cell sorter data, the mapping process comprising one or more of a clustering process, a dimensionality reduction process, an embedding, a non-parametric embedding, or a combination thereof.

8. The method of claim 7, wherein the embedding comprises a uniform Manifold Approximation and Projection (UMAP), a t-distributed Stochastic Neighbor Embedding (t-SNE), another nonlinear embedding, or a combination thereof.

9. The method of claim 2, wherein the machine learning model transforms cell sorter data having a higher number of dimensions to a representation of the transformed cell sorter data having a lower number of dimensions.

10. The method of claim 2, wherein the cell sorter data comprises quantitative fluorescence data expressed as one or more of antibodies bound per cell, antibody binding capacity (ABC), or molecules of equivalent soluble fluorochrome (MESF), one or more other quantitative indicators of fluorescence, or one or more combinations thereof.

11. The method of claim 10, wherein the fluorescence signals are derived from one or more fluorescent proteins, one or more fluorescent dyes, one or more fluorescently conjugate antibodies, one or more populations of fluorescent beads or fluorescently labeled beads, or one or more combinations thereof.

12. The method of claim 2, wherein the machine learning model comprises a neural network.

13. The method of claim 2, wherein the machine learning model is trained without prior determination of a first representation of the first cell sorter data.

14. The method of claim 12, wherein the neural network is trained to learn the mechanism of a mapping process for generating one or more representations of the cell sorter data for a cell sorter measurement session.

15. The method of claim 12, wherein the neural network comprises one or more of an artificial neural network, a convolutional neural network, a recurrent neural network, or one or more combinations thereof.

16. The method of claim 12, wherein the neural network processes cell sorter data enabling cell sorting events equal to or greater than 100,000 events per second.

17. The method of claim 2, wherein the sample comprises a biological sample comprising a plurality of cells.

18. The method of claim 2, wherein the classification is based on one or more cellular phenotypic markers.

19. The method of claim 2, wherein the cell sorter comprises one or more processors, wherein the one or more processors pass the classification of the second cell sorter data to the cell sorter for sorting the portion of the sample.

20. A method for displaying flow-cytometry data in real-time, the method comprising:
outputting, via the user interface associated with a cell sorter, a representation of a first portion of a sample;
receiving, via a user interface, an instruction to generate a machine learning model for the sample, wherein the machine learning model is trained based on a mapping process for mapping cell sorter data to an embedding space;
receiving, via the user interface, an instruction to process a second portion of the sample, wherein the instruction process comprises an instruction to sort the sample using the machine learning model; and
outputting, via the user interface and based on the machine learning model, a representation of the second cell sorter data.
